(19) United States
(12) Patent Application Publication
(10) Pub. No.: US 2024/0260569 A1
(43) Pub. Date: Aug. 8, 2024

(54) DISINFECTANT LIQUID, PREPARATION METHOD THEREOF AND FILM LAYER

(71) Applicant: Shanghai Anpas New Materials Science & Technology Co., Ltd., Shanghai (CN)

(72) Inventors: Wei Yang, Suzhou (CN); Gaofeng Pan, Suzhou (CN); Mengshi Lu, Suzhou (CN)

(21) Appl. No.: 18/568,248

(22) PCT Filed: Jun. 9, 2022
(86) PCT No.: PCT/CN2022/097826

§ 371 Date: Dec. 7, 2023

(30) Foreign Application Priority Data
Jun. 16, 2021 (CN) 202110666587.X
Jul. 5, 2021 (CN) 202110755895.X

(51) Int. Cl. A01N 25/02; A01N 41/06; A01N 43/04; A01N 43/50; A01N 47/42; A01N 59/00; A01P 1/00; A01P 3/00; C09D 5/14

(52) U.S. Cl. CPC A01N 25/02; A01N 41/06; A01N 43/04; A01N 43/50; A01N 47/42; A01N 59/00; A01P 1/00; A01P 3/00; C09D 5/14

(57) ABSTRACT

The disclosure provides a disinfectant liquid capable of realizing long-lasting and effective disinfection and sterilization, a preparation method therefor and a film layer. The disinfectant liquid comprises: an active chlorine source accounting for 0.05-20 wt % of the total weight of the disinfectant liquid; an active chlorine stabilizer accounting for 0.05-20 wt % of the total weight of the disinfectant liquid; and a pH buffering agent accounting for 0.05-5 wt % of the total weight of the disinfectant liquid, so that the disinfectant liquid has a pH between 5.5 and 9.0. The disinfectant liquid can provide active chlorine at a stable concentration for a long time, or can sustainably release active chlorine for a long time, thereby providing the function of sustainably and effectively killing various viruses, bacteria, molds, fungi and spores for a long time.

### CROSS-REFERENCE TO RELATED APPLICATIONS

This application is a U.S. national stage filing under 35 U.S.C. 371 of International Application No. PCT/CN2022/097826, filed Jun. 9, 2022, which claims priority to Application No. 202110666587.X, filed Jun. 16, 2021, in China and Application No. 202110755895.X, filed Jul. 5, 2021, in China. The entire teachings of the above applications are hereby incorporated by reference in their entirety. International Application No. PCT/CN2022/097826 was published under PCT Article 21(2) in Chinese.

### TECHNICAL FIELD

The present application relates to the technical field of disinfection and sterilization, in particular, to a disinfectant liquid capable of sustainably and effectively killing various viruses, bacteria, molds, fungi and spores for a long time, and a preparation method therefor. Furthermore, the present application relates to an aqueous disinfectant liquid which has excellent stability and is capable of sustainably and effectively killing various viruses, bacteria, molds, fungi and spores for a long time, a preparation method therefor, and use thereof for forming a thin film on a solid surface.

### BACKGROUND

Extensive efforts have long been made to prevent the spread of infectious diseases. Today, humans are still facing the threat of infectious diseases. The consequences of infectious diseases caused by various viruses, bacteria, molds, fungi and spores, for example SARS, Covid-19, etc., are even more serious. The contaminated environments play a key role in the spread of various viruses, bacteria, molds, fungi and spores. The surfaces and interior walls in, for example, homes, offices, schools, shopping malls, hospitals and other buildings provide conditions for the residence and spread of various viruses, bacteria, molds, fungi and spores. Cross-infection is a main cause of the explosive infections of various viruses, bacteria, molds, fungi and spores. Strict infection controlling measures are adopted in an attempt to reduce the approaches and opportunities for infection by various viruses, bacteria, molds, fungi and spores. A key factor in the spread of various viruses, bacteria, molds, fungi and spores is their ability to survive in the environment. Covid-19 can survive for 3 weeks under cold-chain conditions. Haemophilus can survive on an article surface for 12 days.

The existing disinfectants can kill various viruses, bacteria, molds, fungi and spores, but they are seriously insufficient in long-term effectiveness or have adverse effects on the human body, environment, items, etc. For example, both ethanol and sodium hypochlorite are effective at killing a variety of viruses, bacteria, molds, fungi, and spores. However, ethanol is easily volatile, has an expiration time of only a few minutes, and is flammable and explosive, posing huge safety risks. Sodium hypochlorite, as commonly used, has inherent strong alkalinity (the pH of a 10% solution thereof is around 12) and corrosiveness and has a strong chlorine smell, which will release chlorine gas to corrode the skin, respiratory tract, and items, making it unsafe and inconvenient to use. Accidents caused by improper use of sodium hypochlorite occur from time to time. WO2017/132324A1 reported that an aqueous sodium hypochlorite solution is very unstable when the pH is less than 10. After 14 days at 55° C., when pH is 9.4, the active chlorine loss is 63%; when pH=8.7, the active chlorine loss is 94%. Moreover, the aqueous sodium hypochlorite solution is extremely unstable, and after drying, sodium hypochlorite disproportionates into sodium chloride and sodium chlorate and no longer has a disinfecting effect. Sodium dichloroisocyanurate is also an excellent disinfectant, but it is unstable in aqueous solution, which affects the possibility of its production and use as an aqueous solution product. Its active chlorine loses about 50% within a week. Therefore, the sodium dichloroisocyanurate disinfection system can only be formulated and used immediately. It is sometimes extremely inconvenient or even impossible to formulate and use it immediately on a large scale in tons.

Therefore, it is urgently desired for a long-lasting, stable disinfectant with a pH close to neutral, which can have the ability to sustainably and effectively kill various viruses (especially coronaviruses), bacteria, molds, fungi and spores over a long period of time, and can achieve the goal of not harming the human body, not affecting the environment, and not corroding items, thereby solving the difficulties of long-term disinfection, environmental safety and the like of disinfectants and the films thereof formed by drying. At present, this type of disinfectant has not yet appeared in the field of epidemic prevention.

### SUMMARY

The inventors surprisingly discovered that certain chlorine-containing disinfectants can be combined with a piperidine-type compound and/or a sulfonamide compound, especially, with a piperidine-type compound and a sulfonamide compound, to form a compound that is relatively stable at neutral pH. Under the action of the chemical equilibrium principle, this compound sustainably releases active chlorine to maintain the chemical equilibrium concentration thereof. The further addition of a surfactant and/or a film-forming protective agent can enable the active chlorine to stably exist in the system for several months when the pH is close to neutral, and still have the ability to kill viruses, bacteria, molds, fungi and viruses for a long time after forming a film layer. That is, it has the function of sustainably and effectively killing various viruses, bacteria, molds, fungi and spores for a long time. Accordingly, the present disclosure was completed.

Therefore, one aspect of the present disclosure provides a disinfectant liquid comprising: an active chlorine source accounting for 0.05-20 wt %, preferably 1-10 wt % of the total weight of the disinfectant liquid; an active chlorine stabilizer accounting for 0.05-20 wt %, preferably 0.1-10 wt % of the total weight of the disinfectant liquid; and a pH buffering agent accounting for 0.05-5 wt %, preferably 0.1-2 wt % of the total weight of the disinfectant liquid.

In the present invention, the active chlorine source is a substance capable of providing active chlorine, and can be selected from a group consisting of sodium hypochlorite, sodium dichloroisocyanurate, dichlorodimethylhydantoin, bromochlorohydantoin, sodium p-toluenesulfonyl chloramine (chloramine-T) and sodium benzenesulfonyl chloramine (chloramine-B).

In the present invention, the active chlorine stabilizer can be selected from a group consisting of a piperidine-type compound and a sulfonamide compound, and is preferably selected from a group consisting of piperidine, tetramethylpiperidinol, hydroxypiperidine, piperidinecarbinol, p-toluenesulfonamide, benzene sulfonamide, and any combination thereof.

In the present invention, the pH buffering agent makes the pH of the disinfectant liquid between 5.5 and 9.0, and can be selected from a group consisting of phosphoric acid, boric acid, salicylic acid and citric acid.

The disinfectant liquid provided in the disclosure may further comprise a film-forming protective agent accounting for 0.05-5 wt %, preferably 0.1-2 wt % of the total weight of the disinfectant liquid; and/or a synergistic enhancer accounting for 0.05-5 wt %, preferably 0.1-2 wt % of the total weight of the disinfectant liquid.

In the present invention, the film-forming protective agent can be selected from a group consisting of methyl cellulose, hydroxyethyl methyl cellulose, carboxymethyl cellulose, ethyl cellulose, benzyl cellulose, hydroxyethyl cellulose, hydroxypropyl methyl cellulose, cyanoethyl cellulose, benzyl cyanoethyl cellulose, carboxymethyl hydroxyethyl cellulose, phenyl cellulose, polyvinylpyrrolidone, polyacrylic acid, polyacrylamide, polyethylene glycol, polyvinyl alcohol, polymaleic anhydride and polyquaternium salts.

In the present invention, the synergistic enhancer may be selected from a group consisting of sodium lauryl sulfate, sodium dodecyl sulfonate and sodium dodecyl benzene sulfonate.

The disinfectant liquid of the disclosure satisfies at least one of the following conditions: (1) the disinfectant liquid has a pH close to neutral, between 5.5 and 9.0, preferably between 6.0 and 8.0; (2) the disinfectant liquid sustainably releases active chlorine for at least 2 months, or even for 6 months or more; (3) the disinfectant liquid has no strong smell or corrosiveness; (4) the disinfectant liquid forms a thin film on a solid surface after drying, and the thin film maintains the function of sustainably and effectively killing viruses, bacteria, molds, fungi and spores for at least 2 months, or even 6 months.

Another aspect of the present disclosure provides a method for preparing the above disinfectant liquid, comprising: adding the active chlorine source and the active chlorine stabilizer to water and stirring it uniformly; optionally, adding the film-forming stabilizer and/or the synergistic enhancer to the aqueous solution obtained in previous step, and stirring it uniformly; adding the pH buffering agent to make the pH of the solution to be between 5.5 and 9.0.

The present disclosure further provides a film layer, which is a thin film formed on a solid surface by the above disinfectant liquid.

The film layer satisfies at least one of the following conditions: (1) the film layer remains sustainably and effectively releasing active chlorine for at least 2 months, or even 6 months; (2) the film layer has the function of steadily killing viruses, bacteria, molds, fungi and spores for a long time (at least 2 months, or even 6 months).

The disinfectant liquid of the present disclosure can provide a stable concentration of active chlorine for a long time, or sustainably release active chlorine for a long time, so that it has the ability to sustainably and effectively kill various viruses (especially coronaviruses), bacteria, molds, fungi and spores over a long period of time. Furthermore, the disinfectant liquid can achieve the goal of not harming the human body, not affecting the environment, and not corroding items. Thus, the disinfectant liquid of the present disclosure has the characteristics of long-lasting effect, stability, neutral pH and non-corrosion, thereby solving the difficulties of disinfectants and the films thereof formed by drying, such as long-term disinfection and environmental safety.

The sodium hypochlorite, sodium dichloroisocyanurate, dichlorodimethylhydantoin, bromochlorohydantoin, chloramine-T and chloramine-B, which can be used as the active chlorine source of the present invention, have been proven to kill various viruses, bacteria, molds, fungi and spores in a short period of time, and their disinfection and sterilization effects are definite.

The active chlorine source of the present disclosure not only has good compatibility with water and can be uniformly dispersed/dissolved in water, but also can be attached to the film layer to sustainably release active chlorine for a long time. In the present invention, the active chlorine source can form a relatively stable N—Cl bond-containing compound with a sulfonamide compound and/or a piperidine-type compound, preferably with a sulfonamide compound and a piperidine-type compound. Under the action of the chemical equilibrium principle, this compound sustainably releases active chlorine to maintain the chemical equilibrium concentration of active chlorine.

In the present invention, active chlorine exists in the form of hypochlorous acid and hypochlorite ions, and its action mechanism includes the action of hypochlorous acid, neooxygenation and chlorination. Hypochlorous acid acts on bacterial and viral proteins. It not only interacts with the cell wall, and because the molecules are small and uncharged, it can also penetrate the cell membrane and invade the interior of the cell, oxidizing the DNA and mitochondria inside the cell or/and destroying the phosphate dehydrogenase, thereby disrupting sugar metabolism and leading to cell death. The oxidizing property of neo-oxygen denatures proteins and other substances in bacteria and viruses, and the chloride ions produced significantly change the osmotic pressure of bacteria and viruses, thereby killing the pathogenic microorganisms.

In the present invention, the addition of a pH buffering substance makes the pH of the system close to neutral, between 5.5 and 9.0. Under different pH conditions, the existing proportions of chlorine gas, hypochlorous acid and hypochlorite ions in the aqueous solution containing active chlorine are quite different. When the pH is less than 5.5, chlorine and hypochlorous acid are dominant, and the lower the pH, the higher the proportion of chlorine. When the pH is 5.5 to 9.0, hypochlorous acid and hypochlorite ions are dominant, and the lower the pH, the higher the proportion of hypochlorous acid. When the pH is 6 to 6.5, the proportion of hypochlorous acid is the largest. When the pH is greater than 9.0, hypochlorite ions are dominant.

In Patent Document WO2017/132324A1, the pH of sodium hypochlorite is only adjusted to about 10 with a buffering solution, and when the pH is less than 10, it is very unstable. The present disclosure surprisingly found that in the presence of active chlorine stabilizer, the pH can be stably adjusted to 5.5 to 9.0, preferably to 6.0 to 8.0. Within this pH range, active chlorine exists more in the form of hypochlorous acid, which has stronger capabilities of disinfection and sterilization (The disinfection and sterilization ability of hypochlorous acid molecules is 80 to 100 times greater than that of hypochlorite ions).

In the present invention, the incorporation of a film-forming protective agent allows the formation of a thin film on the solid surface. The film layer can ensure that the disinfectant adheres to the solid surface, thereby maintaining the function of long-term and effective killing of viruses, bacteria, molds, fungi and spores. In the present invention, the film-forming protective agent has strong hydrophilicity and has moisture absorbing and moisturizing function. During the moisture evaporation, the active chlorine content in the film layer gradually increases, and its capabilities of disinfection and sterilization become stronger and stronger. At the same time, after drying to form a film, there is still a certain amount of moisture in the film layer, thereby ensuring that the film layer can sustainably release active chlorine for a long time, so that the film layer has the function of killing viruses, bacteria, molds, fungi and spores stably and for a long time.

The present disclosure further surprisingly discovered that the added synergistic enhancer (a specific anionic surfactant) synergizes with the active chlorine source to enhance the disinfection and sterilization ability. The surfactant is adsorbed on the surfaces of bacteria and viruses through electrostatic and hydrophobic interactions, thereby changing the permeability of the cell membrane and the osmotic pressure of the cells, leading to the loss of cell contents and contact death of microorganisms. Meanwhile, the surfactant binds to the intracellular proteins, denaturing the enzymes and proteins, and thus damaging cell metabolism. Its action mechanism is as follows: the surfactant is adsorbed onto the cell wall and cell membrane on the surface of bacteria and viruses, and then moves towards the site of action, so as to hinder the normal function of semipermeable membrane and penetrate into cells, and subsequently, it inactivates the enzymes, hinders the synthesis of the ribonucleic acid and the proteins, thereby causing protein denaturation or damage to cell walls and cell membranes to kill bacteria and viruses. At the same time, it is accompanied by interference to the microbial enzyme systems. Without wishing to be bound by any theory, it is hypothesized that the addition of the synergistic enhancer in the present disclosure can further improve the stability of active chlorine at near neutral pH. Especially when drying and forming a film in the presence of a film-forming protective agent, the synergistic enhancer can maintain the uniform distribution of the active chlorine source throughout the film layer, so that active chlorine can be released sustainably and stably over a long period of time to achieve the function of long-termly killing viruses, bacteria, molds, fungi and spores.

Therefore, the disinfectant liquid or film layer prepared by the present disclosure can provide a stable concentration of active chlorine for a long time, or sustainably release active chlorine for a long time, thereby achieving long-lasting and effective ability of killing various viruses (especially coronaviruses), bacteria, molds, and fungi and spores, and at the same time, can achieve the goal of not harming the human body, not affecting the environment, and not corroding items, so the disinfectant liquid or film layer has advantages of a long expiration time, good stability, no corrosion, and good safety.

### DETAILED DESCRIPTION

The sources of raw materials in the following examples are listed below.

Chloramine-B, sodium hypochlorite, sodium dichloroisocyanurate, dichlorodimethylhydantoin, chloramine-T, piperidine, tetramethylpiperidinol, hydroxypiperidine, piperidinecarbinol, p-toluenesulfonamide, methyl cellulose, hydroxyethyl cellulose, polyvinylpyrrolidone, polyvinyl alcohol, polyquaternium salts, sodium lauryl sulfate, sodium dodecyl sulfonate, sodium dodecyl benzene sulfonate, phosphoric acid, boric acid, citric acid and other raw materials were obtained from Sinopharm Chemical Reagent Co., Ltd.

The detection methods in the following examples are listed below.

The detection of active chlorine content was carried out according to GB19106-2003.

The tests for Bacteria Killing Rate, Virus Inactivation Rate, Stability Test, Metal Corrosiveness Test, Acute Oral Toxicity Test, Single Complete Skin Irritation Test, and Mutagenicity Test were carried out according to “Technical Specifications for Disinfection” (2002 Edition).

### Example 1

| | Example 1 |
|---|---|
| chloramine-B | 10% |
| tetramethylpiperidinol | 0.2% |
| phosphoric acid | 0.1% |
| citric acid | 0.1% |
| water | balance |
| pH value (freshly formulated) | 6.87 |
| pH value (180 days | 6.96 |
| after formulation) | |
| active chlorine | 26800 mg/L |
| (freshly formulated) | |
| active chlorine | 26600 mg/L |
| (180 days after formulation) | |

### Example 2

| | Example 2 |
|---|---|
| chloramine-T | 2% |
| tetramethylpiperidinol | 0.05% |
| sodium dodecyl sulfonate | 0.05% |
| boric acid | 0.1% |
| water | balance |
| pH value (freshly formulated) | 7.30 |
| pH value (180 days | 7.42 |
| after formulation) | |
| active chlorine | 2800 mg/L |
| (freshly formulated) | |
| active chlorine | 2830 mg/L |
| (180 days after formulation) | |

### Example 3

| | Example 3 |
|---|---|
| sodium dichloroisocyanurate | 2% |
| piperidine | 0.05% |
| sodium dodecyl | 1% |
| benzene sulfonate | |
| phosphoric acid | 0.05% |
| citric acid | 0.05% |
| water | balance |
| pH value | 6.65 |
| active chlorine | 7420 mg/L |
| (freshly formulated) | |
| active chlorine | 7020 mg/L |
| (180 days after formulation) | |

### Example 4

| | Example 4 |
|---|---|
| chloramine-T | 2% |
| tetramethylpiperidinol | 0.2% |
| polyvinylpyrrolidone | 2% |
| boric acid | 3% |
| water | balance |
| pH value (freshly | 6.82 |
| formulated) | |
| pH value (180 days | 7.07 |
| after formulation) | |
| active chlorine | 3100 mg/L |
| (freshly formulated) | |
| active chlorine | 2980 mg/L |
| (180 days after formulation) | |

### Example 5

| | Example 5 |
|---|---|
| sodium dichloroisocyanurate | 20% |
| piperidinecarbinol | 1% |
| polyquaternium | 0.6% |
| sodium dodecyl sulfonate | 1% |
| phosphoric acid | 0.3% |
| citric acid | 0.3% |
| water | balance |
| pH value (freshly | 7.18 |
| formulated) | |
| pH value (180 days | 7.30 |
| after formulation) | |
| active chlorine | 72500 mg/L |
| (freshly formulated) | |
| active chlorine | 71800 mg/L |
| (180 days after formulation) | |

### Example 6

| | Example 6 |
|---|---|
| sodium hypochlorite | 2% |
| tetramethylpiperidinol | 0.2% |
| p-toluenesulfonamide | 2% |
| polyvinylpyrrolidone | 0.5% |
| sodium lauryl sulfate | 1% |
| phosphoric acid | 0.1% |
| citric acid | 0.1% |
| water | balance |
| pH value (freshly | 7.26 |
| formulated) | |
| pH value (180 days | 7.35 |
| after formulation) | |
| active chlorine | 10860 mg/L |
| (freshly formulated) | |
| active chlorine | 10520 mg/L |
| (180 days after formulation) | |

### Example 7

| | Example 7 |
|---|---|
| dichlorodimethylhydantoin | 2% |
| hydroxypiperidine | 0.5% |
| polyvinyl alcohol | 1% |
| sodium dodecyl | 1% |
| benzene sulfonate | |
| phosphoric acid | 0.1% |
| citric acid | 0.1% |
| water | balance |
| pH value (freshly | 6.85 |
| formulated) | |
| pH value (180 days | 7.02 |
| after formulation) | |
| active chlorine | 7360 mg/L |
| (freshly formulated) | |
| active chlorine | 7250 mg/L |
| (180 days after formulation) | |

### Example 8

| | Example 8 |
|---|---|
| chloramine-B | 0.05% |
| tetramethylpiperidinol | 0.05% |
| methyl cellulose | 0.05% |
| sodium lauryl sulfate | 0.05% |
| boric acid | 0.05% |
| water | balance |
| pH value (freshly | 6.50 |
| formulated) | |
| pH value (180 days | 6.68 |
| after formulation) | |
| active chlorine | 116 mg/L |
| (freshly formulated) | |
| ctive chlorine | 108 mg/L |
| (180 days after formulation) | |

### Example 9

| | Example 9 |
|---|---|
| chloramine-T | 10% |
| tetramethylpiperidinol | 0.2% |
| hydroxyethyl cellulose | 0.6% |
| sodium lauryl sulfate | 1% |
| phosphoric acid | 0.1% |
| citric acid | 0.1% |
| water | balance |
| pH value | 6.36 |
| active chlorine | 24800 mg/L |
| stability test | passed |
| metal corrosiveness test | no corrosion |
| Acute Oral Toxicity Test | nontoxic |
| single complete skin irritation test | non-irritating |
| mutagenicity test | no micronucleogenic |
| | effect |
| Killing Rate against Staphylococcus | 99.999% |
| Aureus (diluted 10 times, | |
| action for 1 minute) | |
| Killing Rate against E. Coli | 99.999% |
| (diluted 10 times, action for 1 minute) | |
| Killing Rate against Pseudomonas | 99.999% |
| Aeruginosa (diluted 10 times, | |
| action for 1 minute) | |
| Killing Rate against Candida Albicans | 99.999% |
| (10 minutes of action) | |
| Killing Rate against Aspergillus Niger | 99.999% |
| (20 minutes of action) | |
| Killing Rate against natural bacteria | 90% |
| (20 minutes of action) | |
| Inactivation Rate against Poliovirus | 99.99% |
| Inactivation Rate against 229E Coronavirus | 99.99% |
| Killing Rate against Bacillus Subtilis | 99.999% |
| Black Variant Spores (60 minutes of action) | |

### Example 10

| | Example 10 |
|---|---|
| chloramine-T | 2% |
| tetramethylpiperidinol | 0.2% |
| hydroxyethyl cellulose | 0.3% |
| sodium dodecyl benzene sulfonate | 0.05% |
| boric acid | 2.6% |
| water | balance |
| pH value | 7.10 |
| active chlorine | 3250 mg/L |
| Killing Rate against influenza A | 99.99% |
| virus H3N2 (5 minutes) | |

### Comparative Examples 1-2

| | | Comparative | Comparative |
|---|---|---|---|
| | Example 3 | Example 1 | Example 2 |
| sodium dichloroisocyanurate | 2% | 2% | — |
| piperidine | 0.05% | 0.05% | 0.05% |
| sodium dodecyl | 1% | — | 1% |
| benzene sulfonate | | | |
| phosphoric acid | 0.05% | 0.05% | 0.05% |
| citric acid | 0.05% | 0.05% | 0.05% |
| water | balance | balance | balance |
| pH value | 6.65 | 6.62 | 6.60 |
| active chlorine | 7420 mg/L | 7415 mg/L | — |
| (freshly formulated) | | | |
| active chlorine | 7020 mg/L | 7030 mg/L | — |
| (180 days after formulation) | | | |
| Killing Rate against | 99.999% | 82.68% | 5.16% |
| E. Coli (diluted 20 | | | |
| times, action for 1 minute) | | | |

### Comparative Examples 3-4

| | Example | Comparative | Comparative |
|---|---|---|---|
| | 7 | Example 3 | Example 4 |
| dichlorodimethylhydantoin | 2% | 2% | — |
| hydroxypiperidine | 0.5% | 0.5% | 0.5% |
| polyvinyl alcohol | 1% | 1% | 1% |
| sodium dodecyl | 1% | — | 1% |
| benzene sulfonate | | | |
| phosphoric acid | 0.1% | 0.1% | 0.1% |
| citric acid | 0.1% | 0.1% | 0.1% |
| water | balance | balance | balance |
| pH value (freshly formulated) | 6.85 | 6.83 | 6.81 |
| pH value (180 days | 7.02 | 7.01 | 7.00 |
| after formulation) | | | |
| active chlorine | 7360 mg/L | 7365 mg/L | — |
| (freshly formulated) | | | |
| active chlorine | 7250 mg/L | 7260 mg/L | — |
| (180 days after formulation) | | | |
| Killing Rate against | 99.999% | 81.50% | 5.18% |
| Staphylococcus Aureus | | | |
| (diluted 20 times, action | | | |
| for 1 minute) | | | |

### Comparative Examples 5-6

| | | Comparative | Comparative |
|---|---|---|---|
| | Example 10 | Example 5 | Example 6 |
| chloramine-T | 2% | 2% | — |
| tetramethylpiperidinol | 0.2% | 0.2% | 0.2% |
| hydroxyethyl cellulose | 0.3% | 0.3% | 0.3% |
| sodium dodecyl | 0.05% | — | 0.05% |
| benzene sulfonate | | | |
| boric acid | 2.6% | 2.6% | 2.6% |
| water | balance | balance | balance |
| pH value | 7.10 | 7.09 | 7.08 |
| active chlorine | 3250 mg/L | 3250 mg/L | — |
| Killing Rate against | 99.99% | 90.00% | 1.26% |
| influenza A virus H3N2 | | | |
| (action for 5 minutes) | | | |

In summary, the present disclosure prepares a disinfectant liquid and a film layer formed therefrom capable of effectively and sustainably killing various viruses (especially coronaviruses), bacteria, molds, fungi and spores for a long time. This disinfectant liquid or film layer can provide a stable concentration of active chlorine for a long time, or can sustainably release active chlorine for a long time, thereby achieving long-lasting and effective ability of killing various viruses (especially coronaviruses), bacteria, molds, and fungi and spores. Meanwhile, it is harmless to the human body, does not affect the environment, does not corrode items, and thus has advantages of a long expiration time, good stability and good safety.

The specific examples of the present disclosure have been described in detail above, but the disclosure is not limited to these specific examples. For those skilled in the art, any equivalent modifications and substitutions to the present disclosure are also within the scope of the present disclosure.

1. A disinfectant liquid, wherein the disinfectant liquid is an aqueous disinfectant liquid, comprising:
an active chlorine source accounting for 0.05-20 wt % of the total weight of the disinfectant liquid, which is selected from a group consisting of sodium hypochlorite, sodium dichloroisocyanurate, dichlorodimethylhydantoin, bromochlorohydantoin, chloramine-T and chloramine-B;
an active chlorine stabilizer accounting for 0.05-20 wt % of the total weight of the disinfectant liquid, which is selected from a group consisting of a piperidine-type compound and a sulfonamide compound; and
a pH buffering agent accounting for 0.05-5 wt % of the total weight of the disinfectant liquid, so that the disinfectant liquid has a pH between 5.5 and 9.0.

2. The disinfectant liquid according to claim 1, wherein the pH buffering agent is selected from a group consisting of phosphoric acid, boric acid, salicylic acid and citric acid.

3. The disinfectant liquid according to claim 1, wherein the active chlorine stabilizer is selected from a group consisting of piperidine, tetramethylpiperidinol, hydroxypiperidine, piperidinecarbinol, p-toluenesulfonamide, benzene sulfonamide, and any combination thereof.

4. The disinfectant liquid according to claim 1, wherein the disinfectant liquid further comprises at least one of the following ingredients:
a film-forming protective agent accounting for 0.05-5 wt % of the total weight of the disinfectant liquid; and
a synergistic enhancer accounting for 0.05-5 wt % of the total weight of the disinfectant liquid.

5. The disinfectant liquid according to claim 4, wherein the film-forming protective agent is selected from a group consisting of methyl cellulose, hydroxyethyl methyl cellulose, carboxymethyl cellulose, ethyl cellulose, benzyl cellulose, hydroxyethyl cellulose, hydroxypropyl methyl cellulose, cyanoethyl cellulose, benzyl cyanoethyl cellulose, carboxymethyl hydroxyethyl cellulose, phenyl cellulose, polyvinylpyrrolidone, polyacrylic acid, polyacrylamide, polyethylene glycol, polyvinyl alcohol, polymaleic anhydride and polyquaternium salts.

6. The disinfectant liquid according to claim 4, wherein the synergistic enhancer is selected from a group consisting of sodium lauryl sulfate, sodium dodecyl sulfonate and sodium dodecyl benzene sulfonate.

7. The disinfectant liquid according to claim 1, wherein the disinfectant liquid satisfies at least one of the following conditions:
(1) the pH of the disinfectant liquid is close to neutral, between 6.0 and 8.0;
(2) the disinfectant liquid sustainably releases active chlorine for at least 2 months, or even for 6 months or more;
(3) the disinfectant liquid has no strong smell or corrosiveness;
(4) the disinfectant liquid forms a thin film on a solid surface after drying, and the thin film maintains the function of sustainably and effectively killing viruses, bacteria, molds, fungi and spores for at least 2 months, or even 6 months.

8. A method for preparing the disinfectant liquid according to claim 1, wherein the method comprises:
(1) adding the active chlorine source and the active chlorine stabilizer to water and stirring it uniformly;
(2) optionally, adding the film-forming stabilizer and/or the synergistic enhancer to the aqueous solution obtained in step (1), and stirring it uniformly;
(3) adding the pH buffering agent to make the pH of the solution to be between 5.5 and 9.0.

9. A film layer, wherein the film layer is a thin film formed on a solid surface by the disinfectant solution according to claim 1.

10. The film layer according to claim 9, wherein the film layer satisfies at least one of the following conditions:
(1) the film layer remains sustainably and effectively releasing active chlorine for at least 2 months, or even 6 months;
(2) the film layer has the function of killing of viruses, bacteria, molds, fungi and spores for at least 2 months, or even 6 months.
